(19) United States
(12) Patent Application Publication
(10) Pub. No.: US 2006/0020395 A1
(43) Pub. Date: Jan. 26, 2006

(54) Method of labeling object, object to which label is attached by the method, and method of distinguishing object by detecting the attached label

(76) Inventor: Tadashi Okamoto, Kanagawa-ken (JP)

Correspondence Address: MORGAN & FINNEGAN, L.L.P., 3 WORLD FINANCIAL CENTER, NEW YORK, NY, 10281-2101, US

(21) Appl. No.: 11/188,163

(22) Filed: Jul. 22, 2005

(30) Foreign Application Priority Data
Jul. 23, 2004 (JP) 2004-215828

(51) Int. Cl. G01N 35/00; G06K 9/00

(52) U.S. Cl. 702/19

(57) ABSTRACT

A method of labeling an object is effective in attaching many species of labels according to the necessity to a minute object such as a fine particulate substrate that is used for fixing a probe molecule to be used in a bioassay. For a minute object, a labeling material prepared in accordance with a composition condition of contained atoms corresponding to at least binary n-digit of numerical information using a species number (n) of plural species of atoms selected in advance is used as a part of materials constituting the object and the presence or absence of the individual selected atoms or two or more content levels thereof is detected.

### BACKGROUND OF THE INVENTION

1. Field of the Invention

The present invention relates to: a method of attaching a label for identification to distinguish the species of individual plural species of objects; an object to which a label for identification is attached by the method; and a method of distinguishing the species of individual objects by detecting a label for identification attached by the method.

2. Related Background Art

When plural species of objects are handled, it is necessary that the species of the individual objects be accurately identified in many cases. In particular, in the case where the plural objects themselves to be handled cannot be easily discriminated by their appearances, labels for identification relating to the species of the individual objects are attached to distinguish the species of the individual objects.

In order to attach a label for identification, various techniques may be used, and essentially, those techniques are intended to allocate encoded identifiers (codes) that may be distinguished to individual species. In the case where the size of an object to be labeled is large, a character string identifier is used in many cases as an encoded identifier (code). For example, a barcode corresponds to information obtained by converting a character string identifier to information on bar line widths and intervals according to a predetermined rule. Note that, for a character string identifier, even if it can fundamentally be expressed by a serial number, in order to simplify their allocation, there may often be adopted a form in which plural hierarchical label elements are combined and integrated to produce one character string identifier such as a phone number consisting of country code, area code, and in-area individual number (in-area exchange number+individual line number).

On the other hand, in the case where the size of an object to be labeled is small, character string identifiers that may be visually distinguished as described above are technically difficult to attach. An IC tag, for example, is therefore adopted, to which a character string identifier is assigned as electronically written information for identification via a digitalized electromagnetic wave by an external detector. The size of such an IC tag itself is of the order of 100 μm and therefore, it is still technically difficult to attach character string identifiers to objects each having a size of several ten μm or less, further more difficult to objects having a size of several μm or less.

Examples of such an object having a size of several ten μm or less, in some cases several μm or less, include a microparticle on which a probe molecule is fixed for detecting biological materials.

When various microbes are classified, a technique for investigating taxonomical relationship by evaluation of cross-reactivity between an antibody molecule specific to an allied species of microbe and an antigen on the surface of the target microbe has been used from a long time ago. At that time, the antibody molecule to be used as a probe is fixed on the surface of each gold fine particle, and accumulation of the gold fine particles in the vicinity of the microbe is observed to judge whether a cross-reaction has occurred or not. Meanwhile, as a method of specifying epitope sequences to be identified by various antibody molecules, there is widely known a technique for separating, for example, an Escherichia coli strain expressing a peptide to perform antigen-antibody reaction with an antibody molecule fixed on the surface of a ferrite microparticle, by using the panning method, from a random peptide library displayed by Escherichia coli. In such a method, when the ferrite particles are magnetically collected, only an Escherichia coli strain expressing a peptide having an amino acid sequence reactive with the antibody molecule is separated while coupled with each ferrite particle.

A principal advantage of using a microparticle for fixing on its surface a probe molecule used for detecting biological materials is to easily separate a substance to be detected, which is conjugated with a probe molecule, from contaminants existing in a liquid phase by using means for separating a microparticle that is a solid matter from a liquid phase. That is, the substance to be detected, existing in a liquid phase, is conjugated with a probe molecule, and then the conjugate including the substance to be detected and the probe molecule and unreacted probe molecules are once separated/collected from the liquid phase by using the microparticles for fixing probe molecules. Subsequently, it is examined whether the conjugate including the substance to be detected and the probe molecule exists or not in a mixture of the collected conjugate including the substance to be detected and the probe molecule and the unreacted probes, and the amount of the existing conjugate is further quantified.

The advantage that a probe molecule is easily separated by fixing the molecule on the surface of a solid phase is still achieved by fixing the probe molecule on the surface of a solid-phase substrate having a macroscopic size. For example, when the presence or absence of a specific IgG antibody existing in an analyte sample is detected, an antigen peptide having an epitope sequence for the IgG antibody to be detected is fixed on the surface of a solid-phase substrate at a predetermined density, the analyte sample is brought into contact with the surface of the solid-phase substrate, and the IgG antibody to be detected is fixed on the surface of the solid-phase substrate through a reaction with the antigen peptide. Thereafter, the analyte sample is removed from the surface of the solid-phase substrate by washing, and then an anti-IgG antibody on which a detection label is attached is allowed to react quantitatively with Fc region (constant region) of the IgG antibody molecule fixed on the surface of the solid-phase substrate. The unreacted “anti-IgG antibody on which a label is attached” is removed from the surface of the solid-phase substrate by washing, and then the labeled anti-IgG antibody having quantitatively reacted with the IgG antibody molecule fixed on the surface of the solid-phase substrate is detected and quantified using the detection label.

In the case of a technique for fixing probe molecules on the surface of a macro-size solid-phase substrate, since the solid-phase substrate itself is large, the same surface of the substrate is divided into plural areas, and then different species of probe molecules may be fixed on the respective areas. Specifically, when the surface is divided into plural areas, the respective divided areas are located in an array pattern or in matrix pattern, and then addresses for specifying the respective divided areas are assigned to form a probe-array in which different species of probe molecules are fixed on the individual divided areas. For example, there may be used forms such as: a DNA probe array prepared by fixing plural species of DNA probes to be used for fixing a target nucleic acid molecule containing a base sequence complementary to the base sequence of a nucleic acid probe by probe hybridization reaction; a peptide antigen array prepared by fixing plural species of antigen peptides each having a known amino acid sequence to be used for fixing a target antibody molecule specific to the antigen peptide by an antigen-antibody reaction; inversely, an antibody array prepared by fixing plural species of a known specific antibody molecule to be used for fixing a target antigen molecule by an antigen-antibody reaction; a receptor protein array prepared by fixing plural species of a known receptor molecule to be used for fixing a target substrate molecule to a receptor protein by bonding of the substrate molecule on the receptor protein; and the like.

A probe array is used when plural species of target molecules contained in an analyte sample are simultaneously fixed using plural species of relating probe molecules. The used solid-phase substrate itself has a macroscopic size, so that separation of the substrate from a liquid phase and a subsequent washing operation are very easily performed. Meanwhile, when a target substance fixed on a substrate is detected as a conjugate with each probe molecule on a probe array, the position to be fixed (address) of each probe molecule has been determined in advance, so that each target substance is detected according to each address.

A probe array prepared by fixing probe molecules on the surface of a macro-size solid-phase substrate has an advantage of easy handling in separation from a liquid phase or in detection of a target substance, and it is used in various fields. However, it has an essential disadvantage that the reaction yield is relatively low (the apparent reaction rate is slow) owing to a reaction of probe molecules fixed on a specific area with a target molecule contained in an analyte sample on the surface of a macro-size solid-phase substrate. Specifically, while the probe molecules are fixed on a limited area on the surface of the solid-phase substrate, the target molecules contained in the analyte sample are uniformly distributed to the overall liquid phase, so that target molecules reactive to the probe molecules are limited to molecules existing in the area near the surface of the solid-phase substrate. When a conjugate is formed by conjugating the target molecules existing in the limited area with the fixed probe molecules, the concentration of “free target molecules” existing in the liquid phase rapidly drops in the area, resulting in relative lowering of the reaction rate. Eventually, there is a limit to the reaction yield, i.e., the total number of the target molecules that form conjugates with the probe molecules per the total number of the fixed probe molecules. The disadvantage that the reaction yield is relatively low (i.e. the apparent reaction rate is slow) becomes more outstanding as the rate of occupation of the fixed region of each probe molecule becomes lower. In other words, as the species number of probe molecules constituting a probe array increases, the disadvantage becomes more outstanding.

Ideally, the disadvantage is reduced by uniformizing the concentration distribution in a liquid phase by rapidly stirring the reaction solution. However, really, when the surface of a macro-size solid-phase substrate is used, the reaction is often performed in the condition that the reaction solution is gently stirred or is virtually allowed to stand. Even in the case where the reaction yield is relatively low (the apparent reaction rate is slow), the total number of the target molecules that form conjugates with probe molecules, or the reaction yield, is reflected in the initial concentration of the target molecule in the analyte solution. However, when the rate of the occupied area in a fixed region of each probe molecule is lower, the relationship between the total number of the target molecules that form conjugates, or the reaction yield, and the initial concentration of the target molecule in the analyte solution has less linearity. That is, such a fact is one of the causes of decrease in the quantification accuracy in the case of using a high-density probe array prepared by fixing various probe molecules on the same surface of a macro-size solid-phase substrate in high-density matrix form, when the concentration of the target molecules in the analyte solution is quantified by quantifying the target molecules fixed as a conjugate with each probe.

In addition, in constituting a probe array, a lattice-shaped frame region for compartment may be provided around the fixed region of each probe molecule. Alternatively, even in the case where the lattice-shaped frame region is not provided, a non-fixed region of any probe molecule may be present around the fixed region of each probe molecule. In the lattice-shaped frame region or in the non-fixed region of any probe molecule, the surface of a solid-phase substrate is exposed, so that various target molecules are often nonselectively adsorbed thereto. The nonselectively adsorbed target molecules raise a background signal level in detection and cause a systematic error when the difference between the signal level detected in the fixed region of each probe molecule and the background signal level is judged as a signal attributed to target molecules that form conjugates with probe molecules. In addition, the reaction yield is relatively low (the apparent reaction rate is slow), so that the concentration of a target molecule is one of the causes of decrease in the quantification accuracy in the case of using a high-density probe array.

In preparing a probe array, the spotting method performed by applying and fixing separately-prepared probe molecules to a predetermined region to be fixed has been widely used. The spotting method has high reproducibility in the density of probe molecules to be fixed per unit surface area as in the case where probe molecules are fixed on the surfaces of microparticles by feeding the microparticles in a liquid containing separately-prepared probe molecules. Meanwhile, when DNA probe (oligonucleotide) molecules that may be synthesized are fixed in an array pattern by a solid-phase reaction, there may be used a method performed by using oligonucleotides to be successively synthesized as probe molecules to be fixed according to a base sequence of each DNA probe (oligonucleotide) on the surface of a macro-size solid-phase substrate by the photolithography method. For the oligonucleotides to be directly synthesized on the surface of a solid-phase substrate, it is difficult to confirm the base sequence after the synthesis, and an oligonucleotide having a deficiency in a part of bases is often mixed. Alternatively, in principle, all (oligo) nucleotides each having a length shorter by one nucleotide than the other nucleotide exist together at a certain rate. Mixing of a DNA molecule having a different base sequence from a target base sequence is a cause of relative decrease in a reaction yield in a probe hybridization reaction. In some cases, when the DNA molecule having a different base sequence from a target base sequence and a DNA probe molecule to be fixed on another address happen to have a common base sequence, a distinct species of nucleic acid molecule, which is different from an original target nucleic acid molecule, is conjugated on the address. Therefore, mixing of the aforementioned undesirable oligonucleotide is a cause of decrease in quantification accuracy.

Meanwhile, a probe molecule-fixed fine particle obtained by fixing a probe molecule on a microparticle is prepared by a method including feeding a microparticle in a liquid containing separately-prepared probe molecules to fix the probe molecules on the surface, so that a nonselective attachment phenomenon of various target molecules to the surface of the microparticle is substantially suppressed. The probe molecules to be fixed are used after separate preparation and sufficient purification.

The probe molecule-fixed fine particles may generally maintain a state where they are uniformly dispersed in a liquid phase, and a reaction between a solid phase and a liquid phase in micro or a uniform reaction in the whole liquid phase in macro may be performed with target molecules that are uniformly dispersed in the whole liquid phase. Therefore, in the case where the probe molecule-fixed fine particle is used, the disadvantage that the reaction yield is relatively low (the apparent reaction rate is slow), which is outstanding in the case of using a high-density probe array obtained by fixing various species of probe molecules on the surface of a macro-size solid-phase substrate in high-density matrix pattern, is substantially eliminated. Therefore, in the case where a probe molecule-fixed fine particle is used, most of the above-listed causes of decrease in quantification accuracy in a probe array may be avoided when the concentration of target molecules in an analyte solution is quantified by quantifying the target molecules fixed as conjugates with probe molecules.

Generally, the probe molecule-fixed fine particle maintains an advantage that it can easily be separated from a liquid phase after a reaction is performed while it is uniformly dispersed in the liquid phase. For example, there may be used a solid-phase separation method performed by applying filtration or centrifugation method. Meanwhile, in the case where the fine particle itself contains a magnetic material as a principal ingredient, it can be separated from a liquid phase using magnetic force.

Of course, a probe molecule-fixed fine particle is obtained by fixing one species of probe molecule on the surface of each microparticle. Therefore, in the case where many species of probe molecules are used, it is necessary to prepare many species of relating probe molecule-fixed fine particles. Those many species of probe molecule-fixed fine particles are different from each other in probe molecule constituting individual probe molecule-fixed fine particles, but they cannot be distinguished by their appearances. In other words, it is necessary that, for many species of probe molecule-fixed fine particles, used microparticles can be distinguished from each other and the individual probe molecule-fixed fine particles be specified. That is, a label for mutual identification must be attached to a used microparticle.

There have been proposed some techniques for attaching a label for mutual identification to a microparticle constituting a probe molecule-fixed fine particle. Examples thereof include a technique for performing identification by the difference in size of used microparticles, which is disclosed in Japanese Patent Application Laid-Open No. S61-225656; a technique for performing discrimination by combining the difference in size of microparticles with fluorescent labels (total: n species), which is disclosed in Japanese Patent Application Laid-Open No. S62-81566; a technique for performing discrimination by coloring microparticles, which is disclosed in Japanese Patent Application Laid-Open No. S62-195556; a technique for performing discrimination by forming microparticles using different metallic elements, which is disclosed in Japanese Patent Application Laid-Open No. H01-95800; a technique for performing discrimination by staining, which is disclosed in Japanese Patent Application Laid-Open No. H02-299698; a technique for performing discrimination based on the fluorescent wavelength of an inorganic fluorescent material used as microparticles, which is disclosed in Japanese Patent Application Laid-Open No. H07-83927; a technique for performing discrimination by using a semiconductive fluorescent nanocrystal as a microparticle, which is disclosed in U.S. Pat. No. 6,602,671; a technique for performing discrimination by using microparticles having different magnetisms, colors, and shapes, which is disclosed in U.S. Pat. No. 6,440,667; and a technique for performing discrimination by using semiconductive fluorescent nanoparticles as microparticles, which is disclosed in U.S. Pat. No. 6,500,622. Moreover, there is disclosed a technique for giving individual addresses (labels) to respective particles.

In those conventional techniques, the species of microparticles that may be distinguished, i.e., the species of labels are about a dozen species at a maximum, and they have poor expandability in the case where the label species are increased. In particular, those techniques have poor expandability in the case where the label species are increased while commonality in the pore sizes, shapes, and principal components of microparticles is maintained.

### SUMMARY OF THE INVENTION

As described above, in order to judge the presence or absence of various biological materials, contained in a liquid phase, such as nucleic acid molecules, proteins, and sugar chain molecules and to measure the content thereof, there is widely used a technique including forming a conjugate by acting a substance (generally referred to as a probe molecule) that specifically conjugates with a substance to be tested (target substance) and separating the conjugate from the liquid phase. Specifically, there is widely used a technique including fixing a probe molecule on the surface of a solid phase, forming a conjugate with a target substance existing in a liquid phase, and separating the solid phase from the liquid phase. After the separation from the liquid phase, the presence or absence is judged for the target substance constituting the conjugate with the probe molecule, and the amount of the target substance is determined using appropriate detecting means.

At that time, as compared with a probe array prepared by regularly fixing plural species of probe molecules on a solid phase substrate having a large surface area, a probe molecule-fixed fine particle prepared by individually fixing each probe molecule on the surface of a fine particle is significantly superior in reactivity with a target substance in a liquid phase and in quantitativity. Note that, in the case of the probe array, the species of each probe molecule may easily be specified based on the fixed position (address), while in the case of the probe molecule-fixed fine particle, the species of each probe molecule is specified by labeling a fine particle to be used for fixing in advance and by identifying the label.

Some means for attaching a probe to a fine particle have been proposed, but applicable species are limited. In the case where many species of probe molecules are used, it is impossible that individual labels are attached to all of the probes. In particular, in the case where a fine particle is used for fixing a probe molecule, the development of a labeling method that enables increase in the species of labels according to the necessity and has much expandability while maintaining commonalities of the size, form, and main components has been desired.

The present invention solves the aforementioned problems. An object of the present invention is to provide a labeling method that enables increase in the species of usable labels according to the necessity and has much expandability while maintaining commonalities of the shape and main components using a minute object to be labeled.

For solving the aforementioned problems, the inventor of the present invention have made extensive studies. As a result, the inventor has first conceived the following fact. The size of a microparticle to be used, for example, for fixing a probe molecule is selected in several μm or less, in some cases, in a submicron region to disperse it uniformly in a liquid phase. At that time, to uniformize the amount of probe molecules to be fixed on the surface of a microparticle, it is necessary that the particle size of the fine particle to be used be uniformized to uniformize the surface area of each fine particle. Of course, the outward forms of the fine particles must be unified into, e.g., a spherical shape. Moreover, in the case where separately-prepared probe molecules are fixed on the surfaces of the fine particles, if the materials of the surfaces of the fine particles are completely different, it is necessary that different fixing means be used. Specifically, in the case of use of metallic fine particles, if metallic elements constituting each fine particle are completely different, it is necessary that different fixing means be used. Conversely, if means for fixing probe molecules to surfaces are different, the density of the probe molecules to be fixed per unit area is difficult to be unified.

Accordingly, desirable is a labeling method that enables increase in the species of labels according to the necessity and has much expandability while maintaining commonalities of the particle size and shape of a microparticle and main components. The inventor of the present invention has advanced the development of a labeling method that optionally enables increase or decrease in the species of attachable labels according to the necessity and has much expandability while satisfying a requirement of maintaining commonalities of the particle size and shape of the particle and main components and having no ambiguity of identification of the attached labels. As a result, for example, the inventor hasfound out that information may be added by selecting a material capable of containing a subcomponent that may optionally be added as an ingredient in a small amount in addition to principal components as a material used for preparing a microparticle and by using a composition of the subcomponent that may optionally be added. Specifically, the inventor of the present invention has conceived that composition conditions of the contained atoms corresponding to binary n-digit of numerical information may be set by selecting plural species of atoms in advance as a composition of a subcomponent that may optionally be added, selecting the presence or absence of the species number (n) of atoms so that each atom has two levels, and using the species number (n) of plural species of atoms selected in advance and the presence or absence of the individual selected atoms. Through the generalization of the technique, they have conceived that composition conditions of the contained atoms corresponding to M-nary n-digit of numerical information may be set by selecting plural species of atoms in advance, setting plural content levels, e.g., M content levels for the species (n) of atoms so that each atom has two levels, and using the species number (n) of plural species of atoms selected in advance and the content levels of the individual selected atoms. In addition to those conceptions, the inventors of the present invention have confirmed that, for differences of the species number (n) of plural species of atoms selected in advance, the presence or absence of the individual selected atoms or differences of the content levels, the content levels of plural species of atoms selected in advance may be specified by applying various analysis means even if the fine particle has a particle size of several μm or less, and that label information attached as a composition of the subcomponent may be fully distinguished, thereby accomplishing the present invention.

That is, according to one aspect of the present invention, there is provided a method of labeling an object, in which the labeling is intended to attach identification information that enables distinction of individual plural objects to be labeled to the objects, the method including: determining a composition of contained atoms corresponding to binary n-digit of numerical information using a species number (n) of plural species of atoms selected in advance and presence or absence of the selected individual atoms; and labeling the object by attaching the identification information represented as the binary n-digit of numerical information to the object.

According to another aspect of the present invention, there is provided a method for labeling an object, in which the labeling is intended to attach identification information that enables distinction of individual plural objects to be labeled to the objects, the method including: determining a composition of contained atoms corresponding to at least binary n-digit of numerical information using a species number (n) of plural species of atoms selected in advance and two or more content levels of the selected individual atoms; and labeling the object by attaching the identification information represented as the binary n-digit of numerical information to the object.

According to further aspect of the present invention, there is provided a method for labeling an object, in which the labeling is intended to attach identification information, the method comprising: determining a composition of contained atoms corresponding to numerical information using a species number (n) of plural species of atoms selected in advance; and labeling the object by attaching the identification information represented as the numerical information to the object.

According to further aspect of the present invention, there is provided a labeled object having a label comprising at least one species selected from n species of atoms selected in advance in a composition, wherein each content of said n species of atoms in the composition corresponds to predetermined numerical information.

Use of the method of labeling an object according to the present invention enables attachment of many species of labels, according to the necessity, even to a minute object such as a fine particulate substrate to be used for fixing probe molecules to be used for detecting biological materials by using the species number (n) of plural species of atoms selected in advance that are a part of materials constituting the object and the presence or absence of the individual selected atoms or two or more content levels and by using materials for labeling prepared according to the composition conditions of the contained atoms.

### DESCRIPTION OF THE PREFERRED EMBODIMENTS

Preferred embodiments of the present invention will now be described in detail in accordance with the accompanying drawings.

As described above on general descriptions, in the method of labeling an object according to the present invention, a material capable of containing a subcomponent that may optionally be added as an ingredient in a small amount in addition to a principal component is selected as, e.g., a material to be used in producing a microparticle, and the composition of the subcomponent that may optionally be added is used to attach label information. Specifically, the method includes: selecting plural species of atoms in advance as a composition of such a subcomponent that may optionally be added; selecting the presence or absence of the species number (n) of atoms individually so that each atom has two levels; setting a composition condition of the contained atoms corresponding to binary n-digit of numerical information using a species number (n) of plural species of atoms selected in advance and the presence or absence of the selected individual atoms; and attaching label information based on the composition setting of the contained atoms. Moreover, when the technique is generalized, the method enables increase in label species, according to the necessity, by: selecting plural species of atoms in advance; setting plural content levels, e.g., M levels for such species number (n) of atoms so that each atom has M levels; and setting a composition condition of the contained atoms corresponding to M-nary n-digit of numerical information using a species number (n) of plural atoms selected in advance and M content levels of the selected individual atoms, and it has expandability.

According to a first aspect of the present invention, there is provided a method of labeling an object, in which the label is intended to attach identification information that enables distinction of individual plural objects to be labeled to the objects, the method including: determining a composition condition of contained atoms corresponding to binary n-digit of numerical information using a species number (n) of plural species of atoms selected in advance and presence or absence of the selected individual atoms; and attaching the identification information represented as the binary n-digit of numerical information using a label having a composition satisfying the composition condition of the contained atoms.

According to a second aspect of the present invention obtained as a result of providing the first aspect with expandability, there is provided a method of labeling an object, in which the label is intended to attach identification information that enables distinction of individual plural objects to be labeled to the objects, the method including: determining a composition condition of contained atoms corresponding to at least binary n-digit of numerical information using a species number (n) of plural species of atoms selected in advance and two or more content levels of the selected individual atoms; and attaching the discrete identification information represented as the at least binary n-digit of numerical information using a label having the composition satisfying the composition condition of the contained atoms.

In further aspect of the method of labeling an object according to the first or second aspect of the present invention, in the label, if the species number (n) of plural species of atoms selected in advance is 5 or more, the species of the numeric information represented by the species number (n) of the atoms and the presence or absence of the selected individual atoms or the two or more content levels thereof, N≧ΣₙCₘ=2ⁿ−1 (1≦m≦n, m and n are positive integers), is 31 or more.

In the label, if the species number (n) of plural species of atoms selected in advance is 8 or more, the species of the numeric information represented by the species number (n) of the atoms and the presence or absence of the selected individual atoms or the two or more content levels thereof, N≧ΣₙCₘ=2ⁿ−1 (1≦m≦n, m and n are positive integers), is 255 or more.

In the label, if the species number (n) of plural species of atoms selected in advance is 12 or more, the species of the numeric information represented by the species number (n) of the atoms and the presence or absence of the selected individual atoms or the two or more content levels thereof, N≧ΣₙCₘ=2ⁿ−1 (1≦m≦n, m and n are positive integers), is 4,095 or more.

In the label, if the species number (n) of plural species of atoms selected in advance is 16 or more, the species of the numeric information represented by the species number (n) of the atoms and the presence or absence of the selected individual atoms or the two or more content levels thereof, N≧ΣₙCₘ=2ⁿ−1 (1≦m≦n, m and n are positive integers), is 65,535 or more.

As described above, in the methods of labeling an object according to the first and second aspects of the present invention, the shape itself of an object to be labeled is not used in label information and may optionally be selected. Therefore, the shape of the object to be labeled may be selected from shapless fine particle, typical shape fine particle, fiber, or sheet. Alternatively, aside from those shapes, the methods of the present invention may be applied to, e.g., a general solid-phase substrate on which probe arrays are formed as described above. In particular, in order to improve a detection limit and decrease an amount of specimen to be collected, there is recently a tendency to minify the amount of a specimen solution to be allowed to react with a probe array. In that case, the shape and area of the probe array to be used in the reaction are finally minified into 1 mm-order in some cases, so that labeling with a barcode or the like is difficult to perform. Therefore, the methods of the present invention are telling labeling methods.

Meanwhile, the method of labeling an object according to the present invention includes using a species number (n) of plural species of atoms selected in advance and the presence or absence of the selected individual atoms or two or more content levels for a label, and the method may also be applied to, e.g., a magnetic material including plural species of atoms as components. Therefore, a magnetic material may be selected as an object to be labeled.

In addition to the invention of the method of labeling an object according to the present invention that has the construction described above, the present invention provides the invention of a labeled object that is prepared by applying the method of labeling an object. That is, the labeled object according to the present invention is an object to which a label is attached, in which the label is attached by the method of labeling an object according to the present invention that has the construction described above.

As described above, in the methods of labeling an object according to the first and second aspects of the present invention, the shape itself of an object to be labeled is not used in label information. Therefore, for the labeled object according to the present invention, the object shape may optionally be selected. Accordingly, the object shape may be selected from shapeless fine particle, typical shape fine particle, fiber, or sheet. Alternatively, as described above, it may be a general probe array.

Moreover, neither the object shape nor the object size is used in label information. Therefore, for the labeled object according to the present invention, the object size may also be selected optionally depending on its application. For example, for the object size, in the case of the object having a fine particle shape, the size corresponding to the particle size may be selected in the range of 1 nm to 10 μm, while in the case of the object having a fiber or fragment shape, at least two sizes of height, length, and breadth may be selected in the range of 1 nm to 10 μm.

Meanwhile, the method of labeling an object according to the present invention includes using a species number (n) of plural species of atoms selected in advance and the presence or absence of the selected individual atoms or two or more content levels, and the method may also be applied to, e.g., a magnetic material including plural species of atoms as components. Therefore, a magnetic material may be selected as the labeled object according to the present invention.

Furthermore, in addition to the invention of the method of labeling an object according to the present invention that has the construction described above, the present invention provides a method of distinguishing objects from each other by identifying labels of labeled objects prepared by applying the method of labeling an object. That is, the method of distinguishing objects according to the present invention is a method of distinguishing objects to which labels are attached by the method of labeling an object according to the present invention that has the construction described above, the method including: determining a composition condition of contained atoms corresponding to at least binary n-digit of numerical information using a species number (n) of plural atoms selected in advance and the presence or absence of the selected individual atoms or two or more content levels thereof; identifying the presence or absence of individual plural species of atoms selected in advance or two or more content levels thereof using a label having a composition satisfying the composition condition of the contained atoms for the individual plural species of atoms selected in advance in the composition of the label using means capable of detecting the presence or absence or two or more content levels; distinguishing the composition condition of the contained atoms satisfying the composition condition of the label to extract corresponding at least binary n-digit of numerical information; and distinguishing individual objects based on the identification information represented as at least binary n-digit of numerical information.

For example, for the individual plural species of atoms selected in advance, mass spectrometry may be used as means capable of detecting the presence or absence or two or more content levels. At that time, time of flight secondary ion mass spectrometry (TOF-SIMS) is more preferably used as mass spectrometry. Alternatively, for the individual plural species of atoms selected in advance, X-ray photoelectron spectroscopy (XPS) or Auger electron spectroscopy (AES) may be used as means capable of detecting the presence or absence or two or more content levels.

Note that, in using time of flight secondary ion mass spectrometry (TOF-SIMS), X-ray photoelectron spectroscopy (XPS), or Auger electron spectroscopy (AES), those analysis techniques may be applied to analysis of an object to be measured that has two-dimensional spread. For example, in the case where an object is situated on a plane surface, in order to identify the presence or absence or two or more content levels for the individual plural species of atoms selected in advance in the composition of the label, a step for performing two-dimensional imaging on the plane surface where the object is situated may further be provided.

The present invention includes a method of distinguishing and analyzing each labeled object using the aforementioned distinction method.

Hereinafter, the present invention will be described in more detail.

In the method of labeling an object according to the present invention, for a label to be attached to a target object, there is used information inhering in the composition represented by the presence or absence or two or more content levels for plural species (n species) of atoms, which has been selected in advance. Specifically, as plural species (n species) of atoms selected in advance, for example, one species of atom is individually selected from n species of elements that differ from each other, and the presence or absence (two levels) is changed for each atom. As a result, the total species number (N_{TOTAL}) of the compositions each including at least one atom of the plural species (n species) of atoms selected in advance is calculated from N_{TOTAL}=ΣₙCₘ=2ⁿ−1 (1≦m≦n, m and n are positive integers). Alternatively, when the content of each atom is changed based on, e.g., two stages (two levels) of “very small amount and small amount”, the plural species (n species) of atoms selected in advance is included at least in very small amount, and the total species number (N_{TOTAL}) of compositions having differences in the contents is calculated from N_{TOTAL}=2ⁿ.

Meanwhile, for plural species (n species) of atoms selected in advance, when the content is changed based on, e.g., three stages (three levels) of “not contained, very small amount, and small amount”, the total species number (N_{TOTAL}) of the compositions each including at least one atom of the plural species (n species) of atoms selected in advance is calculated from N_{TOTAL}=3ⁿ−1. Furthermore, for one certain species of atom of the plural species (n species) of atoms selected in advance, the content is changed based on, e.g., “not contained, very small amount, and small amount”, while for the other (n−1) species of atoms, the presence or absence (two levels) is changed. As a result, the total species number (N_{TOTAL}) of the compositions each including at least one atom of the plural species (n species) of atoms selected in advance is calculated from N_{TOTAL}=3×(2ⁿ⁻¹)−1. In the aforementioned aspect, formally, for all the plural species (n species) of atoms selected in advance, three stages (three levels) of indicators, e.g., “not contained, very small amount, and small amount”, are set, and for one certain species of atom, the content is changed based on the three stages (three levels) of indicators, while for the other (n−1) species of atoms, among the three stages (three levels) of indicators of “not contained, very small amount, and small amount”, only two species of indicators of “not contained and small amount” are selected. That is, in the aspect, among the total species number of compositions that may be set (N_{TOTAL}=3ⁿ−1), its subset of {3×(2ⁿ⁻¹)−1} species are selected and used. As described above, when, for plural species (n species) of atoms selected in advance, alternatives are diversified by dividing the contents into three stages (three levels), e.g., by dividing the contents into M stages (M levels), the range of the total species number (N_{TOTAL}) Of compositions may be expanded to {Mⁿ−1} species.

As described above, when plural species of atoms are selected in advance as labels to be attached to a target object, and there are used information inhering in the composition represented by the presence or absence or two or more content levels of the species number (n species) of atoms, the aforementioned at least N_{TOTAL}=2ⁿ−1 species of labels may be attached only by changing the contents of plural species (n species) of atoms selected in advance based on two or more levels. That is, in the aforementioned at least N_{TOTAL}=2ⁿ−1 species of labels, when plural species (n species) of atoms selected in advance are related to the respective digits, they are related to at least binary n-digit of numeric.

For a label to be attached to a target object, information inhering in the composition is used, so that the species number (n) of atoms selected in advance is desirably selected appropriately depending on the total species number of the species of target labels. For example, in the case where the species number (n) of atoms selected in advance is 5 or more, the total species number of compositions (N_{TOTAL}) is at least N_{TOTAL}=2⁵−1 based on indicators of the presence or absence or two or more content levels. That is, as the total species number of species of target labels, at least 31 species of labels may be applied. For example, in the case of identification of various microbes, genetic information unique to the individual microbes, e.g., base sequences of rRNA may be used. To discriminate coding regions on a genomic gene corresponding to the base sequences of the rRNA, it is necessary to perform DNA hybridization assay using a DNA probe having many species of base sequences. More specifically, in the case where an infecting organism of an infection disease is identified using DNA hybridization assay, the species of DNA probes to be used is often much more than 31 species. At that time, on a fine particulate substrate on which each DNA probe is fixed, 255 or more species of labels may be attached by setting the species number (n) of atoms selected in advance to eight or more applying the labeling method according to the present invention. Meanwhile, there have been reported much more than 255 species of single nucleotide polymorphisms (SNP) that have been discovered in human genomic gene, DNA probes to be used for detecting individual single nucleotide polymorphisms are desirably distinguished using labels to be attached on a fine particulate substrate to be used for fixation. For example, when the species number (n) of atoms selected in advance is set to 12 or more, 4,095 or more species of labels may be attached, and there may be provided a label corresponding to the portion equivalent to single nucleotide polymorphisms (SNP) that have been discovered in human genomic gene. Moreover, when the species number (n) of atoms selected in advance is set to 16 or more, 65,535 or more species of labels may be attached, and for example, there may be provided labels unique to individual enormous numbers of DNA probe corresponding to all genes that exist in human genome. As described above, the labeling method according to the present invention enables an appropriate increase or decrease in the species number (n) of atoms selected in advance to be used for expression of label information while corresponding to the total species number of a target label species and has expandability capable of adapting extremely wide applications such as mutual differentiation using labels to be attached to a fine particulate substrate to be used for fixation of various probe molecules to be used in various assays.

For example, in a technique disclosed in Japanese Patent Application Laid-Open No. H01-95800, for microbeads to be used for fixing each DNA probe, labeled beads are prepared using one species of separate metallic element, and the species of each DNA probe is specified by analyzing one species of the metallic element by fluorescent X-ray. In the labeling method, there is used, as a label, one species of metallic element such as Cr, Fe, Zn, Ba, or Ti as single-character label information. Therefore, this method is different in the technical idea from a technique for expressing label information corresponding to, e.g., binary n-digit of numerical information using plural species (n species) of atoms selected in advance based on indicators of the content levels as the labeling method according to the present invention. Meanwhile, in a technique disclosed in Japanese Patent Application Laid-Open No. H07-83927, plural species of inorganic fluorescent substances are used to prepare an ultrafine particle substance to be used for fixing probe molecules, fluorescences characteristic of the individual inorganic fluorescent substances are observed, to thereby specify the species of each probe molecule. In this labeling method, there is used, as a label, fluorescences characteristic of the individual plural species of inorganic fluorescent substances as single-character label information. Therefore, this method is different in the technical idea from a technique for expressing label information corresponding to, e.g., binary n-digit of numerical information using plural species (n species) of atoms selected in advance based on indicators of the content levels as the labeling method according to the present invention.

Characteristics of the technical idea will be described in more detail. Even if, in the labeling method according to the present invention, apparently, five species of atoms are selected in advance and used for labeling, the method virtually includes: selecting, e.g., 16 species of atoms as plural species (n species) of atoms selected in advance; relating each atom to, e.g., binary 16-digit of numerical information by allocating it to each corresponding digit; optionally selecting only five species atoms from those atoms; and using {2⁵−1} species of atoms as subset with indicators of the presence or absence thereof. That is, the method may be expanded to fully wide applicable scope in advance, but a part of subset is used depending on the applicable scope.

Meanwhile, in the labeling method according to the present invention, the shape or size of an object itself may optionally be selected as long as the content information relating to a specific atom can be used as a label. For example, in the case where a fine particle to be used for fixing various probe molecules is targeted, the shape is preferably shapless fine particle such as needle, bar, having irregularities or the like, or typical shape fine particle such as sphere or square. Aside from those shapes, in the case where an object in a fiber or sheet shape is employed as a substrate to be used for fixing various probe molecules, the method of labeling an object according to the present invention may preferably applied. In addition, the material of a fine particle to be used for fixing various probe molecules may be a magnetic material. If the form of the magnetic fine particle is selected, there may be applied an operation for separating the fine particle from a liquid phase using magnetic force while fixing various probe molecules.

Note that, a substrate to be used for fixing various probe molecules desirably has a size enough to be dispersed in a liquid phase uniformly. That is, a minute size is generally selected so as to provide good dispersibility in a liquid phase. For example, for a fine particle, the size corresponding to the particle size is desirably selected in the range of 1 nm to 10 μm. Meanwhile, in the case of a substrate in a fiber or fragment form, at least two sizes of height, length, and breadth is desirably selected in the range of 1 nm to 10 μm. In addition, when using a counting performed by applying the aforementioned cytometry method in detection, the aforementioned lower limit of the size is preferably selected to 100 nm or more.

For example, when the method of labeling an object according to the present invention is applied to a fine particle that may be used for fixing various probe molecules, there may be adopted a form that labels are attached after the composition of a material constituting the fine particle itself is diversely changed to make a difference in presence or absence or content levels of plural species (n species) of atoms selected in advance. There may be used: a dry method that includes mixing, sintering, and pulverizing starting materials having a composition ratio regulated to a desirable level; a coprecipitation method in which a coprecipitate containing plural species of atoms is obtained from a solution having a composition ratio regulated to a desirable level; or a spray pyrolysis method that includes dissolution of starting materials, spray-pyrolysis, and shredding. For example, an oxide fine particle in which plural species (n species) of metallic atoms selected in advance are contained in an oxide form may be formed by using a method of producing a fine particle composed of an oxide superconductive material, which is disclosed in Japanese Patent Application Laid-Open No. S64-51322. Meanwhile, a ferrite particle containing plural species (n species) of metallic atoms selected in advance may be formed by using a method of producing a ferrite particle using the coprecipitation method, which is disclosed in Japanese Patent Application Laid-Open No. 2002-128523.

Moreover, there may be adopted a form that a coated fine particle is prepared by applying a coating layer to a core fine particle composed of various materials, and labels are attached after the composition of the material of the coated layer is diversely changed to make a difference in presence or absence or content levels of plural species (n species) of atoms selected in advance. A coated layer having a desirable composition may be formed by the following means using, as a core fine particle, a particle of glass, plastic, silicon, metal, or the like. For example, as a dry method, there may be used: physical vapor deposition (PVD) method such as vacuum deposition, ion plating, or sputtering; chemical vapor deposition (CVD) method; or coated-layer formation disclosed in Japanese Patent Application Laid-Open No. H07-053271, which is performed by applying an air dispersion method. In addition, as substitute for the coated layer, a surface layer may be formed by introducing a desirable element from the surface of a core fine particle using the ion injection method to change the composition of the surface portion.

Note that, in the method of labeling an object according to the present invention, plural species (n species) of atoms selected in advance to be contained in composition ingredients constituting a label are not particularly limited as long as the species can be specified with high accuracy, and the content can be determined with good reproducibility. However, from the viewpoint of maintaining performance required by a target object itself, e.g., magnetic property, a certain degree of limitation is imposed on available elements. Additionally, in some producing methods, some elements are not available in principle. Therefore, with consideration for performance required by a target object itself and a producing method, plural species (n species) of atoms to be used are preferably selected appropriately. At that time, elements satisfying the aforementioned conditions are preferably selected from, e.g., typical metallic elements and transition metallic elements.

As an example, examples of a combination of plural species of atoms to be used include a combination of Co, Ni, Mn, Zn, Cu, Mg, Al, and Ti (in the case of eight species of atoms), a combination of Co, Ni, Mn, Zn, Cu, Mg, Al, Ti, Ga, Ge, Ag, and Pd (in the case of 12 species of atoms), and a combination of Co, Ni, Mn, Zn, Cu, Mg, Al, Ti, Ga, Ge, Ag, Pd, V, Cr, Ru, and Rh (in the case of 16 species of atoms).

Any analysis method may be used as a method of analyzing and detecting an object to which a label is attached according to the present invention as long as it is means for identifying the presence or absence or content levels of plural species of atoms selected in advance to be used as a label. For example, there may be preferably used mass spectrometry such as time of flight secondary ion mass spectrometry (TOF-SIMS), X-ray photoelectron spectroscopy (XPS), or Auger electron spectroscopy (AES). Moreover, those methods capable of performing two-dimensional imaging may be used as detection methods in the case where plural different particles are present in two-dimensional form.

### EXAMPLES

Hereinafter, the present invention will be described in more detail by way of examples. However, those examples are examples of the best modes according to the present invention, and the present invention is not limited to modes shown in those examples.

### Example 1

Based on a method of producing a ferrite fine particle described in Japanese Patent Application Laid-Open No. 2002-128523, a ferrite fine particle was prepared using a solution containing iron (II) ion as an essential ingredient and to which various metallic element ions constituting a ferrite fine particle to be provided were added and using an oxidant to oxidize iron (II) ion to iron (III) ion. When the species or added concentrations of the metallic element ions to be added in the starting solution were selected in addition to principal ingredient iron ion, the prepared ferrite fine particle had a ferrite-material containing various metallic elements in addition to a principal ingredient metallic element of iron at a desired content ratio.

In this example, there were prepared: ferrite fine particles to which one or more species of metallic elements selected from a total of 8 species of metallic elements (Co, Ni, Mn, Zn, Cu, Mg, Al, and Ti) were added as minor ingredient metallic elements in addition to a principal ingredient metallic element (Fe) constituting a ferrite; and a ferrite fine particle to which those 8 species of the metallic elements were not added. That is, ferrite fine particles to which one or more species of metallic elements selected from 8 species of metallic elements (Co, Ni, Mn, Zn, Cu, Mg, Al, and Ti) were added were classified into (2⁸−1) species=255 species depending on the species of contained metallic elements of the 8 species of metallic elements. Further, in combination with a ferrite fine particle to which the 8 species of metallic elements were not added, the prepared ferrite fine particles were classified into a total of 256 species based on the presence or absence of the individual 8 species of the metallic elements in the composition.

Note that, in this example, the concentrations of the respective metallic element ions to be added as minor ingredients were regulated to the same level in a solution containing plural metallic element ions to be used for preparing ferrite fine particles. The particle size of a finally prepared ferrite fine particle was found to be approximately 500 nm.

The prepared ferrite fine particles were separated from each reaction solution and washed with ultrapure water. Note that, in operations for collecting and separating the ferrite fine particles such as: collection and separation from the reaction solution; and collection after washing, there was used a technique for collecting ferrite particles using a magnet. A total of 256 species of washed ferrite fine particles were separately suspended in ultrapure water, to thereby prepare suspensions each having a dispersion density of about 5.5 mg/mL (about 500 particles/μL).

From the resultant suspensions of ferrite fine particles (total: 256 species), about 1 μl of each suspension was taken and mixed, and then the contained ferrite fine particles were once collected. The fine particles were resuspended in 100 μL of pure water, and 1 μL of the resuspension was spotted on copier paper, followed by drying. Subsequently, the copier paper was appropriately cut off, and the composition of metallic elements contained in each ferrite fine particle existing in each spotted portion was measured. In this example, spectra derived from 9 species of metallic elements (Fe, Co, Ni, Mn, Zn, Cu, Mg, Al, and Ti) were measured using TOF-SIMS apparatus (manufactured by ION-TOF USA, Inc.: TOF-SIMS IV), XPS apparatus (manufactured by JEOL: JPS-9200), AES apparatus (manufactured by JEOL: JAMP-9500F) while performing two-dimensional imaging of a region including each spotted portion by three measurement methods.

As a result of the two-dimensional imaging, each image of the region in which the ferrite fine particles existed (spotting position) was obtained from each spotting position by any of three measurement methods based on spectra derived from a principal ingredient metallic element. At the same time, for spectra derived from minor ingredient metallic elements contained in each ferrite fine particle, it was confirmed that spectra unique to at least the individual minor ingredient metallic elements (Co, Ni, Mn, Zn, Cu, Mg, Al, and Ti) can be detected without interference due to other ingredient metallic elements. That is, it was confirmed that a total of 256 species (2⁸ species) of ferrite fine particles can be distinguished by selecting eight species of metallic elements (Co, Ni, Mn, Zn, Cu, Mg, Al, and Ti) as minor ingredient metallic elements that can be blended for a principal ingredient metallic element (Fe) contained in the ferrite fine particles and by attaching a label corresponding to binary 8-digit of numerical information based on the presence or absence of the eight species of metallic elements.

### Example 2

In this Example 2, there were prepared: ferrite fine particles to which one or more species of metallic elements selected from a total of 12 species of metallic elements including eight species of metallic elements (Co, Ni, Mn, Zn, Cu, Mg, Al, and Ti) and four species of metallic elements (Ga, Ge, Ag, and Pd) were added as minor ingredient metallic elements in addition to a principal ingredient metallic element (Fe) constituting a ferrite; and a ferrite fine particle to which those 12 species of the metallic elements were not added. That is, ferrite fine particles to which one or more species of metallic elements selected from 12 species of metallic elements (Co, Ni, Mn, Zn, Cu, Mg, Al, Ti, Ga, Ge, Ag, and Pd) were added were classified into (2¹²−1) species=4,095 species depending on the species of contained metallic elements of the 12 species of metallic elements. Further, in combination with a ferrite fine particle to which the 12 species of metallic elements were not added, the prepared ferrite fine particles were classified into a total of 4,096 species based on the presence or absence of the individual 12 species of the metallic elements in the composition.

Note that, in this example, the concentrations of the respective metallic element ions to be added as minor ingredients were regulated to the same level in a solution containing plural metallic element ions to be used for preparing ferrite fine particles. However, the contents of the individual 12 species of metallic elements to the content of the principal ingredient metallic element (Fe) was lowered to 8/12 of the ratio in Example 1. The particle size of a finally prepared ferrite fine particle was found to be approximately 500 nm.

The prepared ferrite fine particles were separated from each reaction solution and washed with ultrapure water. Note that, in operations for collecting and separating the ferrite fine particles such as: collection and separation from the reaction solution; and collection after washing, there was used a technique for collecting ferrite particles using a magnet. A total of 4,096 species of washed ferrite fine particles were separately suspended in ultrapure water, to thereby prepare suspensions each having a dispersion density of about 5.5 mg/mL (about 500 particles/μL).

From the resultant suspensions of ferrite fine particles (total: 4,096 species), about 1 μl of each suspension was taken and mixed, and then the contained ferrite fine particles were once collected. The fine particles were resuspended in 100 μL of pure water, and 1 μL of the resuspension was spotted on copier paper, followed by drying. Subsequently, the copier paper was appropriately cut off, and the composition of metallic elements contained in each ferrite fine particle existing in each spotted portion was measured by the same measurement procedure and conditions as those of Example 1.

As a result of the two-dimensional imaging for the ferrite fine particles in Example 2, images of regions in which the respective ferrite fine particles exist (spotting positions) may be obtained based on spectrum derived from the principal ingredient metallic element from the respective spotting positions. At the same time, for spectra derived from minor ingredient metallic elements contained in each ferrite fine particle, it was confirmed that spectra unique to at least the individual minor ingredient metallic elements (Co, Ni, Mn, Zn, Cu, Mg, Al, Ti, Ga, Ge, Ag, and Pd) can be detected without interference due to other ingredient metallic elements. That is, it was confirmed that a total of 4,096 species (212 species) of ferrite fine particles can be distinguished by selecting 12 species of metallic elements (Co, Ni, Mn, Zn, Cu, Mg, Al, Ti, Ga, Ge, Ag, and Pd) as minor ingredient metallic elements that can be blended for a principal ingredient metallic element (Fe) contained in the ferrite fine particles and by attaching a label corresponding to binary 8-digit of numerical information based on the presence or absence of the 12 species of metallic elements.

Those results described above revealed that, when the species number of metallic elements that may be selected is further increased as minor ingredient metallic elements in addition to a principal ingredient metallic element (Fe) constituting a ferrite, the species of labels that may be attached to ferrite fine particles can be increased as long as the contents of all of the many species of metallic elements can be evaluated by measuring spectrum unique to the individual metallic elements by applying various detection means.

### Example 3

In this Example 3, there were prepared: ferrite fine particles to which one or more species of metallic elements selected from eight species of metallic elements (Co, Ni, Mn, Zn, Cu, Mg, Al, and Ti) were added in addition to a principal ingredient metallic element (Fe) constituting a ferrite; and a ferrite fine particle to which those eight species of the metallic elements were not added. Note that, in Example 3, in a solution containing plural species of metallic element ions to be used for preparing ferrite fine particles, two levels of the concentration same as that in Example 1 and 1/10 thereof were used for two species (Ni and Zn) with respect to the concentrations of the respective metallic element ions to be added as minor ingredients.

That is, the ferrite fine particles to which one or more species of metallic element selected from eight species of metallic elements (Co, Ni, Mn, Zn, Cu, Mg, Al, and Ti) were added were classified into (2⁶×3²−1) species=575 species based on: the contained metallic element species of six species of metallic elements (Co, Mn, Cu, Mg, Al, and Ti) (the number of occurrences 2⁶); and differences of the content levels for two species (Ni and Zn) (the respective three levels: 0, 1/10, and 1) (the number of occurrences 3²) Further, in combination with a ferrite fine particle to which the eight species of metallic elements were not added, the prepared ferrite fine particles were classified into a total of 576 species (2⁶×3 species) based on the presence or absence of the individual eight species of the metallic elements in the composition. Note that, in this example, the particle size of a finally prepared ferrite fine particle was found to be approximately 500 nm.

From the resultant suspensions of ferrite fine particles (total: 575 species), about 1 μl of each suspension was taken, and then the suspension was spotted on copier paper, followed by drying. Subsequently, the copier paper was appropriately cut off by the same measurement procedure and condition as those of Example 1, and the composition of the metallic elements contained in the ferrite fine particles existing in each spotted portion was measured.

As a result of the two-dimensional imaging for the ferrite fine particles of Example 3, there were obtained images of the respective regions in which the ferrite fine particles existed (spotting position) from the respective spotting position based on spectra derived from the principal ingredient metallic element in any of the three measurement procedures. At that time, for spectra derived from the minor ingredient metallic elements contained in each ferrite fine particle, there were confirmed that spectra unique to at least minor ingredient metallic elements (Co, Ni, Mn, Zn, Cu, Mg, Al, Ti, Ga, Ge, Ag, and Pd) can be measured and that differences in the content levels of two species (Ni and Zn) can clearly be distinguished. That is, it was confirmed that a total of 576 species (2⁶×3² species) of ferrite fine particles can be distinguished by selecting eight species of metallic elements (Co, Ni, Mn, Zn, Cu, Mg, Al, and Ti) as minor ingredient metallic elements that may be blended for a principal ingredient metallic element (Fe) contained in a ferrite fine particle and attaching labels corresponding to more than binary 8-digit of numerical information, e.g., labels corresponding to binary 6-digit and ternary 2-digit of numerical information based on differences in the content levels of the eight species of metallic elements.

The above-described results revealed that, for species number (n) of metallic elements that may be selected as minor ingredient metallic elements in addition to a principal ingredient metallic element (iron), labels corresponding to, e.g., M-nary n-digit of numerical information can be attached to ferrite fine particles as long as not only the presence or absence but also plural of content levels (level number M) of all of the n-species of metallic elements can be evaluated by measuring spectra unique to individual metallic elements by applying various detection means.

Use of the method of labeling an object according to the present invention enables attachment of many species of labels, according to the necessity, to a minute object such as a fine particulate substrate to be used for fixing probe molecules to be used in, e.g., bioassay. In other words, fixation of predetermined probe molecules on the surface of a fine particulate substrate to which labels have been attached in advance by applying the method of labeling an object according to the present invention enables easy attachment of labels that may be used for distinguishing the species of individual probe molecules to many species of probe molecules fixed on a fine particle.

The present invention is not limited to the above embodiments and various changes and modifications can be made within the spirit and scope of the present invention. Therefore, to apprise the public of the scope of the present invention the following claims are made.

This application claims priority from Japanese Patent Application No. 2004-215828 filed on Jul. 23, 2004, which is hereby incorporated by reference herein.

1. A method for labeling an object, in which the labeling is intended to attach identification information that enables distinction of individual plural objects to be labeled to the objects, the method comprising:
determining a composition of contained atoms corresponding to binary n-digit of numerical information using a species number (n) of plural species of atoms selected in advance and presence or absence of the selected individual atoms; and
labeling the object by attaching the identification information represented as the binary n-digit of numerical information to the object.

2. A method for labeling an object according to claim 1, wherein, in the label, the species number (n) of plural species of atoms selected in advance is 5 or more, and the number of the numeric information represented by the species number (n) of the atoms and the presence or absence of the selected individual atoms, N≧ΣₙCₘ=2ⁿ−1 (1≦m≦n, m and n are positive integers), is 31 or more.

3. A method for labeling an object according to claim 2, wherein, in the label, the species number (n) of plural species of atoms selected in advance is 8 or more, and the number of the numeric information represented by the species number (n) of the atoms and the presence or absence of the selected individual atoms, N≧ΣₙCₘ=2ⁿ−1 (1≦m≦n, m and n are positive integers), is 255 or more.

4. A method for labeling an object according to claim 2, wherein, in the label, the species number (n) of plural species of atoms selected in advance is 12 or more, and the number of the numeric information represented by the species number (n) of the atoms and the presence or absence of the selected individual atoms, N≧ΣₙCₘ=2ⁿ−−1 (1≦m≦n, m and n are positive integers), is 4,095 or more.

5. A method for labeling an object according to claim 2, wherein, in the label, the species number (n) of plural species of atoms selected in advance is 16 or more, and the number of the numeric information represented by the species number (n) of the atoms and the presence or absence of the selected individual atoms, N≦ΣₙCₘ=2ⁿ−1 (1≦m≦n, m and n are positive integers), is 65,535 or more.

6. A method for labeling an object according to claim 1, wherein a shape of the object to be labeled is selected from an shapeless fine particle, typical shape fine particle, fragment, fiber, and sheet.

7. A method for labeling an object according to claim 6, wherein the object to be labeled comprises a magnetic material.

8. A method for labeling an object, in which the labeling is intended to attach identification information that enables distinction of individual plural objects to be labeled to the objects, the method comprising:
determining a composition of contained atoms corresponding to at least binary n-digit of numerical information using a species number (n) of plural species of atoms selected in advance and two or more content levels of the selected individual atoms; and
labeling the object by attaching the identification information represented as the at least binary n-digit of numerical information to the object.

9. A method for labeling an object according to claim 8, wherein, in the label, the species number (n) of plural species of atoms selected in advance is 5 or more, and the number of the numeric information represented by the species number (n) of the atoms and one of: the presence or absence of the selected individual atoms; and the two or more content levels thereof, N≧ΣₙCₘ=2ⁿ−1 (1≦m≦n, m and n are positive integers), is 31 or more.

10. A method for labeling an object according to claim 9, wherein, in the label, the species number (n) of plural species of atoms selected in advance is 8 or more, and the number of the numeric information represented by the species number (n) of the atoms and one of: the presence or absence of the selected individual atoms; and the two or more content levels thereof, N≧ΣₙCₘ=2ⁿ−1 (1≦m≦n, m and n are positive integers), is 255 or more.

11. A method for labeling an object according to claim 9, wherein, in the label, the species number (n) of plural species of atoms selected in advance is 12 or more, and the number of the numeric information represented by the species number (n) of the atoms and one of: the presence or absence of the selected individual atoms; and the two or more content levels thereof, N≧ΣₙCₘ=2ⁿ−1 (1≦m≦n, m and n are positive integers), is 4,095 or more.

12. A method for labeling an object according to claim 9, wherein, in the label, the species number (n) of plural species of atoms selected in advance is 16 or more, and the number of the numeric information represented by the species number (n) of the atoms and one of: the presence or absence of the selected individual atoms; and the two or more content levels thereof, N≧ΣₙCₘ=2ⁿ−1 (1≦m≦n, m and n are positive integers), is 65,535 or more.

13. A method for labeling an object according to claim 8, wherein a shape of the object to be labeled is selected from an typical shape fine particle, shapeless fine particle, fragment, fiber, and sheet.

14. A method for labeling an object according to claim 13, wherein the object to be labeled comprises a magnetic material.

15. A labeled object comprising the label attached by the labeling method according to claim 1.

16. A labeled object according to claim 15, wherein a shape of the object is selected from an shapeless fine particle, typical shape fine particle, fiber, fragment, and sheet.

17. A labeled object according to claim 16, wherein for a size of the object, in a case of an object having a fine particle shape, a size corresponding to its particle size is in a range of 1 nm to 10 μm, while in a case of an object having one of a fiber shape and a fragment shape, at least two sizes of height, length, and breadth are selected in a range of 1 nm to 10 μm.

18. A labeled object according to claim 17, wherein the object comprises a magnetic material.

19. A method of distinguishing objects labeled by the method of labeling according to claim 8, the method comprising:
determining a composition of contained atoms corresponding to at least binary n-digit of numerical information using a species number (n) of plural atoms selected in advance and one of: presence or absence of the selected individual atoms; and two or more content levels thereof;
identifying one of: the presence or absence of individual plural species of atoms selected in advance; and two or more content levels thereof using means capable of detecting one of: the presence or absence; and two or more content levels;
distinguishing the composition of the contained atoms satisfying the composition of the label to extract at least corresponding binary n-digit of numerical information; and
distinguishing individual objects based on identification information represented as the at least binary n-digit of numerical information.

20. A method of distinguishing objects according to claim 19, wherein mass spectrometry is used as means capable of detecting one of: the presence or absence of the individual plural species of atoms selected in advance; and content levels thereof.

21. A method of distinguishing objects according to claim 20, wherein the mass spectrometry is time of flight secondary ion mass spectrometry (TOF-SIMS).

22. A method of distinguishing objects according to claim 19, wherein one of X-ray photoelectron spectroscopy (XPS) and Auger electron spectroscopy (AES) is used as means capable of detecting one of: the presence or absence of the individual plural species of atoms selected in advance; and content levels thereof.

23. A method of distinguishing objects according to claim 21, further comprising, in a case where the object is situated on a plane surface, performing two-dimensional imaging on the plane surface on which the object is situated for identifying one of: presence or absence; and two or more content levels of the individual plural species of atoms selected in advance in the composition of the label.

24. An analysis method comprising identifying and analyzing each labeled object using the distinction method according to claim 19.

25. A method for labeling an object, in which the labeling is intended to attach identification information, the method comprising:
determining a composition of contained atoms corresponding to numerical information using a species number (n) of plural species of atoms selected in advance; and
labeling the object by attaching the identification information represented as the numerical information to the object.

26. A labeled object having a label comprising at least one species selected from n species of atoms selected in advance in a composition, wherein each content of said n species of atoms in the composition corresponds to predetermined numerical information.

27. A labeled object comprising the label attached by the labeling method according to claim 2.

28. A labeled object comprising the label attached by the labeling method according to claim 3.

29. A labeled object comprising the label attached by the labeling method according to claim 4.

30. A labeled object comprising the label attached by the labeling method according to claim 5.

31. A labeled object comprising the label attached by the labeling method according to claim 6.

32. A labeled object comprising the label attached by the labeling method according to claim 7.

33. A labeled object comprising the label attached by the labeling method according to claim 8.

34. A labeled object comprising the label attached by the labeling method according to claim 9.

35. A labeled object comprising the label attached by the labeling method according to claim 10.

36. A labeled object comprising the label attached by the labeling method according to claim 11.

37. A labeled object comprising the label attached by the labeling method according to claim 12.

38. A labeled object comprising the label attached by the labeling method according to claim 13.

39. A labeled object comprising the label attached by the labeling method according to claim 14.
